(19) United States
(12) Patent Application Publication
(10) Pub. No.: US 2015/0195693 A1
(43) Pub. Date: Jul. 9, 2015

(54) EARTHQUAKE EARLY WARNING SYSTEM UTILIZING A MULTITUDE OF SMART PHONES

(71) Applicants: RAMIN HOORIANI, Tarzana, CA (US); RAFI ISRAEL, Malibu, CA (US)

(72) Inventors: RAMIN HOORIANI, Tarzana, CA (US); RAFI ISRAEL, Malibu, CA (US)

(21) Appl. No.: 14/147,502

(22) Filed: Jan. 4, 2014

(51) Int. Cl. H04W 4/22; H04M 1/725; H04W 4/02

(52) U.S. Cl. CPC H04W 4/22; H04W 4/027; H04W 4/023; H04M 1/72538; H04W 88/06

(57) ABSTRACT

A mobile phone and tablet based earthquake early warning system that utilizes the on board accelerometer, gyroscope, GPS and other location and movement sensing technologies built into today's mobile smart phones and tablet devices to quickly detect an earthquake event and immediately send an alarm to those in nearby locations that could be adversely affected by the event.

### FIELD OF INVENTION

The present invention belongs to the field of earthquake early warning systems and generally relates to a devices, methods, systems and arrangements to accurately detect the occurrence of an earthquake and immediately warn the participants. More particularly, the present invention is an earthquake early warning system that utilizes position and movement information from a multitude of smart phones and tablet devices within a geographic area to quickly and accurately detect the occurrence of an earthquake and immediately warn the participants, of the imminent threat of an earthquake.

### BACKGROUND OF THE INVENTION

Much of the damage and injury caused by earthquakes could be prevented if early warning of a destructive earthquake were available.

The way in which this has been done up to now is through positioning seismic sensors around earthquake fault lines and based on the amplitude and type of seismic waves, alerting those who sign up for receiving the early warnings in the event of an earthquake.

Although this technology has been proven to be effective, the cost of operating large number of seismic sensors in remote locations has made the cost of these services prohibitively high and out of the reach of most consumers.

Earthquake waves travel through earth at speeds close to that of speed of sound, but communication networks messages travel at speeds close to speed of light. The difference in these speeds makes it possible to detect earthquakes and transmit early warning messages to people in danger zones (depending on their location) prior to the arrival of earthquake's waves.

The occurrence of an earthquake causes a great cost of life and heavy damage to property. A scale of seismic intensity is a measure used to indicate the strength of vibrations of an earthquake at a site, i.e. a compilation of human perception and a shaking pattern of surrounding things or a structure. The seismic intensity scale is represented using acceleration (cm/sec2) or acceleration of gravity (1 g=980 cm/sec2), wherein cm/sec2 is represented by gal, and 1 g corresponds to 980 gal. A conventional earthquake alert system predicts the occurrence of an earthquake by detecting a seismic intensity scale and minimizes damage caused by the earthquake by controlling operations of dangerous devices or allowing the emergency management agency to notify people of the occurrence of the earthquake by various means. However, due to the very fast propagation speed of earthquakes, it is very difficult to quickly cope with the earthquakes, resulting in severe accidents, and in the case of a slight (minor) shock of an earthquake, a user cannot easily perceive the earthquake in an initial stage. Thus, a method of notifying of the occurrence of an earthquake as soon as possible is still insufficient. Accordingly, a method of detecting the occurrence of an earthquake using wireless terminals has become popular to people and quickly notifying users of the occurrence of the earthquake is suggested in order to minimize damage caused by the earthquake.

Various patents have been filed for earthquake sensing and warning through different devices.

U.S. Pat. No. 7,042,365 discloses a seismic switch which is a programmable device capable of distinguishing between seismic movements due to an earthquake or an explosion, which is used to send a signal to control panels for security doors. The device uses accelerometers and a microcontroller for the detection and signal analysis of the seismic movements. In the event of an explosion or earthquake, the device produces a loud sound which serves as an audible alarm. Other proposed applications, with minor modifications to the device or software code, include monitoring of freight handling, emergency shut-off controller for industrial control systems and machinery, a by-pass system for electronic access control panels, and as a theft-deterrent or a component of a security system for automated teller machines and other valuable devices or items

United States Patent Application 20120324278 describes a method and apparatus that allow a user to easily operate a self-service device despite the presence of damage is provided. Anticipated damage includes extreme environmental conditions such as earthquakes, flooding, strong winds, tsunamis, etc. These conditions may cause a failure in a portion of the self-service device. Improved ruggedness and redundant components are coordinated by suitable software to provide service despite damage to the self-service device. Additionally, access to some user accounts despite the loss of connectivity to a server maintaining user accounts is provided.

U.S. Pat. No. 5,252,786 claims a multi-function earthquake alerting apparatus. It is designed and built as an average household item with simple and durable mechanical parts. It can serve as a decorative item. However, when an earthquake happens, it will serve as an information center in a quick glance. The essential functions of the present invention earthquake alerting apparatus include indicating the direction of the epicenter of a major earthquake, providing an auditory alert for small warning shocks and after shocks, and providing information on the exact time of the earthquake.

U.S. Pat. No. 4,484,186 discloses a novelty for apparently indicating earthquakes, including a circular base marked with concentric circles on its upper side defining different earthquake intensities, a frame upon the base supporting a freely depending electrical contact through a supported circular contact so that in case the device is tilted, the contacts touch and thus close a circuit to a warning alarm.

U.S. Pat. No. 6,670,889 describes a mechanical transmission system for transmitting a wafer to a semiconductor manufacturing machine and being able to break off automatically in response to an earthquake via receiving a control signal generated by an earthquake detecting device is provided. The system includes a mechanical transmission device for transmitting the wafer to the semiconductor manufacturing machine, a warning device for generating a warning signal in response to the control signal, and a control circuit electrically coupling to the mechanical transmission device and breaking off in response to the control signal for avoiding the damage of the mechanical transmission device or the semiconductor-manufacturing machine caused by the earthquake.

United States Patent Application 20110130113 claims a communication device of the present invention that includes: a communication section; an earthquake information calculation section for receiving an earthquake early warning by using the communication section; a control section for forcibly disconnecting a telephone line if the earthquake early warning has been received while the telephone line is connected; and a disconnection reason notification section for transmitting, if the telephone line has been forcibly disconnected due to the reception of the earthquake early warning, disconnection reason information, which indicates a disconnection reason, to a communication counterpart previously participating in a phone call with the communication device. The disconnection reason notification section refers to association information in which telephone numbers and e-mail addresses are associated with each other and thereby obtains an e-mail address associated with a telephone number for which the forcible disconnection has been performed. The disconnection reason notification section generates and transmits an e-mail that contains the disconnection reason to the obtained e-mail address.

U.S. Pat. No. 7,006,000 discloses an earthquake detecting and warning device for detecting a vibration of the earth's surface is provided. The device includes a base, a top cover, at least a contact-conducting piece, a detecting and warning circuit, a shelling body and an elastic supporting component. When an earthquake occurs, the shelling body will receive the vibration from all direction to swing accordingly so that the lower portion of the shelling body will be contacted with a corresponding set of contact-conducting piece mounted on a plate body of the base to form a loop with the detecting and warning circuit. Therefore, a sound unit will generate a warning voice to inform the user. Then, the user can interrupt the warning voice through pressing a pressing component so as to press the shelling body so that the lower portion of the shelling body will totally and simultaneously connected with all sets of contact-conducting pieces.

However although the prior art patents focus on earthquake warning and sensing, none of them yet provide a cost-effective method that gives the users of the system a few seconds to prepare for the arrival of an earthquake. None of the prior art patents provide a solution for quick warning whereby where an earthquake has been detected, an alarm will be sent to participating mobile phones within certain proximity of the detected earthquake over the same wireless network. \

Thus there remains a long felt need for a cost effective and easy to use and install earthquake warning system which has hitherto not been commercially available.

The present invention apparatus and method intends to offer a novel approach to providing such an earthquake warning system.

The objective of the present invention is to achieve a low cost earthquake early warning system.

It is a further object of the present invention to provide an earthquake early warning system that gives the users of the system a few seconds to prepare for the arrival of an earthquake.

It is a further object of the present invention to provide an earthquake early warning system that uses a large number of sensors to protect against false alarms and measure the velocity of seismic waves through earth and based on distance of travel determine exact time of impact.

### SUMMARY OF THE INVENTION

The main task, which is the target of this invention, is to ensure a simple, convenient and reliable user friendly earthquake warning system.

The invention described herein generally embodies a mobile software application that will be loaded on participating smart phones and tablet devices most of which have built in accelerometer, gyroscope, GPS and other location and movement sensing systems, and that will periodically send the location and movement data of the mobile phone to one or more servers over one of the available network connections such as cellular, Wi-Fi, 3G, and 4G networks. If an earthquake has been detected, an alarm will be sent to participating mobile phones within certain proximity of the detected earthquake over the same wireless network.

### BRIEF DESCRIPTION OF THE DRAWINGS

The following drawings illustrate preferred embodiments of the apparatus of the present invention.

FIG. 1 is a flowchart of a preferred embodiment of the present invention illustrating how devices send periodic location messages to the server, keeping the server up to date of their most recent location.

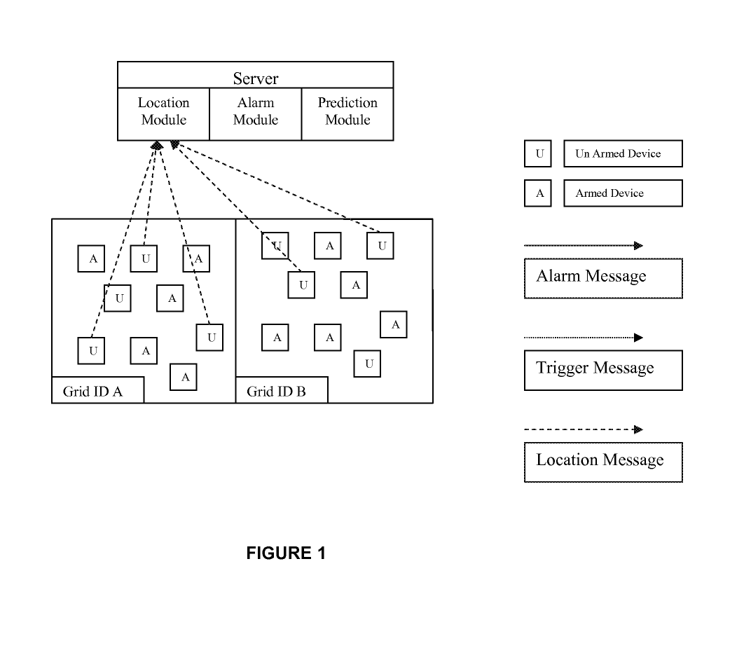

FIG. 2 is a flowchart of a preferred embodiment of the present invention illustrating how an Armed message is sent to the server when the device is sitting completely idle for a predetermined number of seconds. In response to this message the server will reply with an Active or In-Active response to the device.

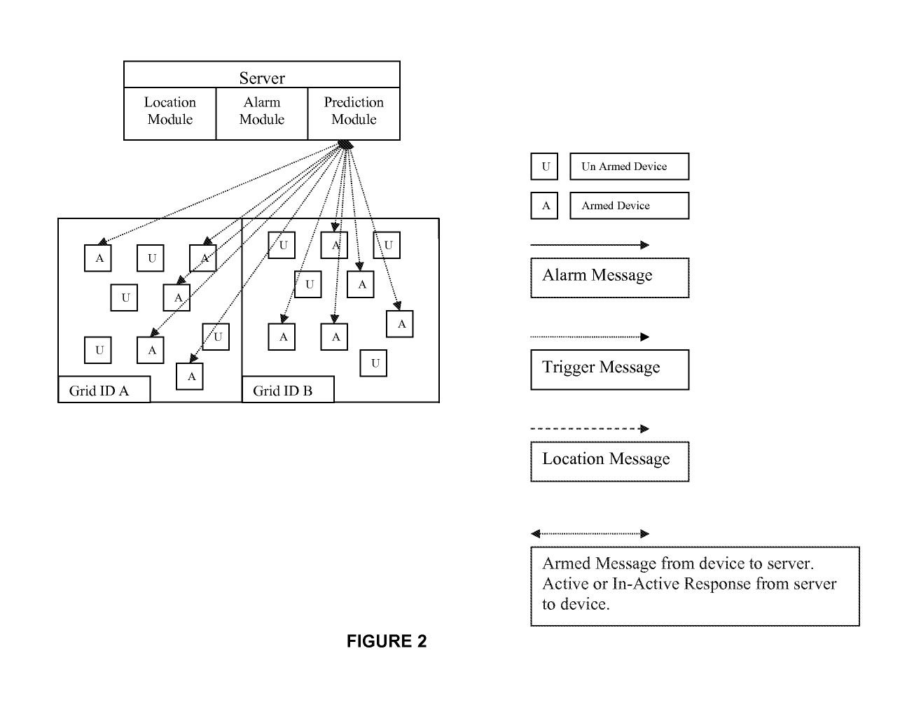

FIG. 3 is a flowchart of a preferred embodiment of the present invention illustrating how in case of an earthquake, a number of Armed Active devices send synchronous trigger messages to the server which causes the detection of the earthquake. In response to this, the Alarm module will send Alarm messages to the devices in the vicinity of the detected earthquake.

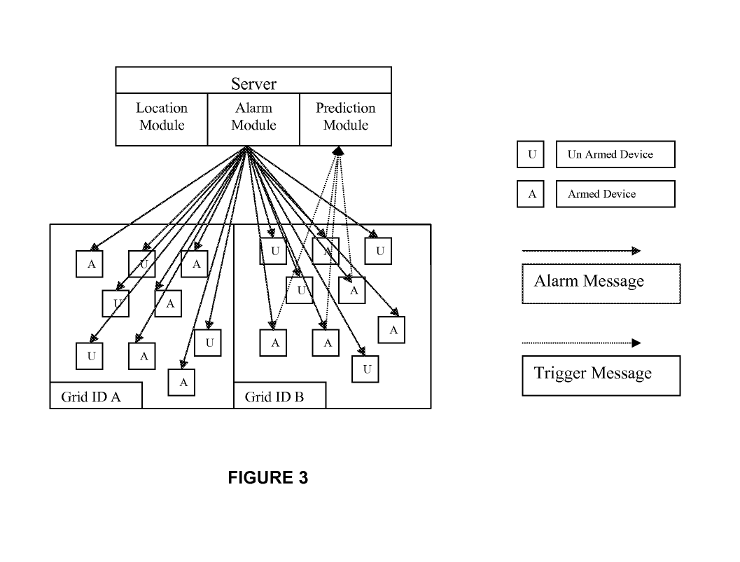

### DETAILED DESCRIPTION OF THE INVENTION

In this invention, earthquake monitoring, analyzing and alarm system using an embedded hardware and software uses the tri-axial acceleration transducer, the embedded hardware and software, and mode identification technology to solve the universality, accessibility, effectiveness, accuracy, reliability difficult problems of the earthquake monitoring, analyzing and alarm, improves the situations of the high cost, strong specificity and the like of the existing similar instruments. The earthquake monitoring, analyzing and alarm warning system can intelligently analyze and record seismic data, promptly discovers and sends out imminent earthquake exceptional warning and earthquake warning, is connected with a mobile device.

The general purpose of the present invention is to provide a low cost earthquake early warning system that gives the users of the system a few seconds to prepare for the arrival of an earthquake. Earthquakes are seismic waves that have a speed as they travel through earth. By having a large number of sensors the velocity of seismic waves through earth can be measured and based on distance of travel, exact time of impact can be determined.

To accomplish this, a mobile software application will be loaded on participating smart phones and tablet devices and with modifications in table computers, most of which have built in accelerometer, gyroscope, GPS and other location and movement sensing systems. This mobile application will periodically send the location and movement data of the mobile device to one or more servers over one of the available network connections such as cellular, Wi-Fi, 3G, and 4G networks. The central servers will store this data in databases and place the mobile devices into different Grids based on their location and will filter the received data with geographical and acceleration filters to detect the likelihood of an earthquake event. In the event where an earthquake has been detected, an alarm will be sent to participating mobile phones within certain proximity of the detected earthquake over the same wireless network.

Mobile phone's available modes, messages and their definition:

Under this application, during normal use each mobile phone is usually in one of a limited number of modes.
Off: Device is in off mode.
   No Data Activity
In-Use (In-Hand or In-Pocket or In-Car): User is using the device or moving
   a Send Infrequent Location message. Location messages will be sent based on time or change of location.
Armed
   After a number of seconds of no movement, device enters the Armed mode and sends an Armed Message to the server.
   In response an Armed message, the server will send a reply message that puts the device in one of the two following modes:
      Armed Active—The device will send a Triggered message in response to an earthquake like movement.
      Armed In Active—The device will NOT send a Triggered message in response to an earthquake like movement.
Triggered
   If the device is moved while in “Armed Active” Mode, a “Triggered” message is sent to the server with the current time, magnitude of detected acceleration and current location.

There are many ways in which the data from the mobile phones and tablets can be filtered for detection of an earthquake event. But in general, an earthquake event is detected when a number of devices, over a wide geographical area that were sitting idle in “Armed Active” Mode, experience a sudden movement.

It is important to design this system in a way that it does not over burden the wireless network with unnecessary data packets.

According to an exemplary embodiment of the present invention, smart algorithms are used to minimize the transmission of messages without diminishing its early warning capabilities. One such algorithm is to have mobile phones that are in use and are constantly moving to send location information on a very low frequency.

Once a phone is placed down on a surface and it has stopped moving for a pre determined period of time, it enters Armed Mode and will send an Armed Packet to the server. The server will reply to this message with an “Armed-Active” or “Armed-In Active” reply message based on the number of devices that are in Armed Active mode in the selected Grid.

If the device is moved while in this “Armed Active” Mode, it sends a “triggered” message to the central serve.

Based on normal use patterns, at any time, a number of mobile phones will enter this “Armed Active” mode and come out of it by sending a “triggered” message. The key to the early warning system is to detect the sudden transmission of almost synchronous “triggered” messages on a high percentage of mobile phones within a geographic region.

The time it takes for a packet to get from the smart phone to the central server is one of the key factors of the effectiveness of this system. Before a mobile phone sends its “Armed” message to the central server, it could do a ping operation to determine the round trip data transmission time to the central server. This expected transmission time is included in the “Armed” message or the “triggered” message.

It is to be known if a phone is connected to a Wi-Fi system, since the data transmission time is minimized for phones connected to a Wi-Fi system, the first information about the earthquakes will be transmitted thought those phones that are connected to a Wi-Fi network.

Since the signature of movement due to normal use of a phone or tablet is different from that of an earthquake, it is possible for the mobile devices to determine if the detected movement is due to normal use or an earthquake. This type of filtering will dramatically reduce the number of packets transmitted over the network.

According to a further embodiment of the present invention, in the case of an earthquake event the server will send an “Alarm” message to all participating phones within a certain geographical location, notifying them of the detected earthquake. This “Alarm” message includes the estimated location and magnitude of the earthquake. The geographical location of the user and the location and magnitude information for the earthquakes will be displayed to the user on a map user interface. In addition an estimated time to arrival of the earthquake waves is calculated and displayed for the user with a count down timer.

During normal operation, this application is running in the background on the mobile phone and an Icon notifies the user that the application is active.

According to a further embodiment of the present invention, in order to minimize the number of Triggered messages transmitted from Armed devices at the time of an earthquake and also to reduce the likelihood of users trying to cause false alarms in the system by deliberately moving a number of Armed phones, synchronously within a geographical area, an algorithm can be implemented so that only a predetermined number of phones that go into the Armed mode will be set to “Armed Active” mode and be assigned the function of sending a Triggered message. With this algorithm, the owner of a device does not know if his/her device is an “Armed-Active” device and therefore will be less likely to try to induce a false alarm, In addition, this algorithm will reduce the number of Triggered messages sent out in case of an actual earthquake.

In this application, the terminology ‘embodiment’ can be used to describe any aspect, feature, process or step, any combination thereof, and/or any portion thereof, etc. While the invention has been described in connection with specific embodiments thereof, it will be understood that it is capable of further modifications and this application is intended to cover any variations, uses or adaptations of the invention following, in general, the principles of the invention and including such departures from the present disclosure come within known or customary practice within the art to which the invention pertains and may be applied to the essential features hereinbefore set forth.

We claim:

1. An earthquake monitoring, analyzing and alarm warning system built using mobile smart phones and tablet devices to capture and identify data related to earthquakes consisting of a built in accelerometer and, global positioning system or cell tower location identification system or Wi-Fi location identification system, characterized in that:
the location of mobile devices are periodically transmitted to one or more servers over one of the available network connections such as cellular, Wi-Fi, 3G, and 4G networks;
the movements and lack of movement of the mobile devices are periodically transmitted to one or more servers over one of the available network connections such as cellular network, Wi-Fi, 3G, and 4G networks;
the mobile devices are networked together through their communication with the central servers; and
the central servers will filter the received data with geographical and acceleration filters to detect the likelihood of an earthquake event.

2. An earthquake monitoring, analyzing and alarm warning system as claimed in claim 1 wherein the central server will place the mobile phone devices into different Grids based on their location

3. An earthquake monitoring, analyzing and alarm warning system as claimed in claim 1 wherein the velocity of seismic waves through earth can be measured and based on distance of travel, exact time of impact can be determined

4. An earthquake monitoring, analyzing and alarm warning system as claimed in claim 1 wherein in the event where an earthquake has been detected, an alarm will be sent to participating mobile phone devices within certain proximity of the detected earthquake over the same wireless network

5. An earthquake monitoring, analyzing and alarm warning system as claimed in claim 1 wherein when a mobile phone device is “in-use” mode, through in-hand or in-pocket or in-car, the user is using the device or moving it, location messages are being sent based on time or change of location.

6. An earthquake monitoring, analyzing and alarm warning system as claimed in claim 1 wherein when a mobile phone device enters the “armed” mode, after a number of seconds of no movement, and the device sends an “armed” message to the server.

7. An earthquake monitoring, analyzing and alarm warning system as claimed in claim 1 wherein when a mobile phone device is in “armed” mode, in response an “armed” message, the server will send a reply message based on the number of devices that are in “armed active” mode in the selected grid.

8. An earthquake monitoring, analyzing and alarm warning system as claimed in claim 1 wherein when a mobile phone device receives a reply message in “armed” mode, the device may be switched to the “armed active” mode and sends a triggered message in response to a vibration.

9. An earthquake monitoring, analyzing and alarm warning system as claimed in claim 1 wherein when a mobile phone device receives a reply message in device “armed” mode, the device may be switched to the “armed inactive” mode and not send a triggered message in response to a vibration.

10. An earthquake monitoring, analyzing and alarm warning system as claimed in claim 1 wherein an earthquake event is detected when a number of devices, within a grid that were sitting idle in “armed active” mode, experience a sudden vibration and transmit a “triggered” message.

11. An earthquake monitoring, analyzing and alarm warning system as claimed in claim 1 wherein based on normal use patterns, at any time, a number of mobile phones will enter this “armed active” mode and come out of it by sending a “triggered” message, the sudden transmission of synchronous “triggered” messages on a higher than normal percentage of mobile devices within a geographic region being an indicator of seismic activity.

12. An earthquake monitoring, analyzing and alarm warning system as claimed in claim 1 wherein the server will send an “alarm” message to all participating phones within a particular geographical location, notifying them of the detected earthquake, consisting of the estimated location and magnitude of the earthquake, the geographical location of the user and the location and magnitude information for the earthquakes displayed to the user on a map user interface.

13. An earthquake monitoring, analyzing and alarm warning system as claimed in claim 1 wherein an estimated time to arrival of the earthquake waves is calculated and displayed for the user with a count down timer.

14. An earthquake monitoring, analyzing and alarm warning system as claimed in claim 1 wherein if the device is moved while in “armed active” mode, a “triggered” message is sent to the server with the current time, magnitude of detected acceleration and current location.

15. An earthquake monitoring, analyzing and alarm warning system as claimed in claim 1 wherein smart algorithms are used to have smart phones and tablet devices that are in use and are constantly moving to send location information on a very low frequency.

16. An earthquake monitoring, analyzing and alarm warning system as claimed in claim 1 wherein before a mobile phone device sends its “armed” message to the central server, it does a ping operation to determine the round trip data transmission time to the central server, this expected transmission time being included in the “armed” message and the “triggered” message.
